(19) United States
(12) Patent Application Publication
(10) Pub. No.: US 2005/0199260 A1
(43) Pub. Date: Sep. 15, 2005

(54) Cosmetic packaging, typically a compact, with magnetic closer

(76) Inventor: Robert Petit, Cluny (FR)

Correspondence Address: YOUNG & THOMPSON, 745 SOUTH 23RD STREET, 2ND FLOOR, ARLINGTON, VA, 22202, US

(21) Appl. No.: 11/073,685

(22) Filed: Mar. 8, 2005

(30) Foreign Application Priority Data
Mar. 10, 2004 (FR) 04 02483

(51) Int. Cl. H02K 7/00

(52) U.S. Cl. 132/301

(57) ABSTRACT

The compact (1) comprises a cover (2) fitted with a mirror (5) and provided with a first hinge portion (20), a hollow bottom (6) in which the said cosmetic products will be placed, the said bottom (6) being provided with a second hinge portion (60), a hinge (10) formed by cooperation of the said first and second hinge portions (20, 60), a magnetic closure (11) based on cooperation of an upper magnet (21) fixed to the cover (2) with a lower magnet (61) fixed to the said bottom (6) facing the upper magnet, and possibly an applicator of the said cosmetic product, and is characterised in that:
a) the said cover (2) comprises a so-called upper wall (22) forming all or part of a means of attachment of the said upper magnet (21) to the said cover (2), the said upper wall (22) being typically located below the said upper magnet (21) so as to make the said upper magnet (21) invisible even when the said compact (1) is opened,
b) the said bottom (6) comprises a so-called lower wall (62) forming all or part of the said means of attachment of the said lower magnet (61) to the said bottom (6), the said lower wall (62) being typically located above the said lower magnet (61), so as to make the said lower magnet invisible even when the said compact (1) is opened, c) the said magnets are separated by an axial distance D when the said compact is closed, chosen so as to be able to simultaneously obtain a predetermined opening force typically between 1.6 N and 2.6 N, and manual opening and closing of the compact that is not noisy, or even silent, giving an impression of softness.

### DOMAIN OF THE INVENTION

The invention relates to the domain of cosmetic product packaging, and typically powder compacts for face care.

### STATE OF THE ART

In general, compacts typically include:
a hollow cover usually provided with an inner mirror,
a hollow bottom, typically provided with a inner frame or intermediate support of at least one receptacle in which the said cosmetic product will fit,
a hinge, forming the connection device between the said cover and the said bottom about which the said cover opens, thus opening the said compact,
a closer or any other means of locking the said cover to and from the said bottom and unlocking it so as to open and close the said compact, a closer typically being a push button. This closer, on the side opposite to the hinge of the compact, is usually formed by cooperation of a cover closing element and a bottom closing element or the inner frame fixed to the bottom so as to guarantee that the compact will remain closed unless it is intentionally opened.

A wide variety of embodiments of compacts is known, that may relate to one or several components of the compact, particularly on the closer or opening of the compact.

The following patents in the name of the applicant are relevant to this context:
patent FR 2 661 080 that describes a makeup compact with a small closer,
patent FR 2 725 958 related to a compact with edge-to-edge closure and assisted opening,
patent FR 2 737 192 that describes a compact with a pivoting cover provided with a hinge with flexible tabs,
patent FR 2 755 352 that describes a compact with assisted opening,
patent FR 2 755 353 that describes a compact with an unlocking and pre-opening pusher,
and patent FR 2 794 723 that describes a compact with improved pre-opening.
   Problems that Arise

Firstly, the closer of a compact often requires a set of parts that are relatively expensive to produce and assemble.

Secondly, the closer of a compact is usually visible, particularly after the compact has been opened, and frequently the closer fails to contribute to the aesthetics of the compact, and on the contrary reduces the aesthetics of the compact itself particularly when it is opened.

Furthermore, in many cases, manual opening and closing of the compact is not discrete, and may even be noisy.

Furthermore, known closers require a predetermined manual opening force for a given type of closer, which makes it difficult to adapt or modulate the opening force to suit the habits or requirements of users, and these habits or requirements may vary from one country or continent to another.

Furthermore, considering the diversity of compacts, it is also desirable to have a closer that can be used on a large number of different compacts, since this is very advantageous, in particular without needing to redesign each compact.

Finally, another problem is to provide compacts that are different from compacts according to the state of the art, not only by their appearance but also by their “feel” or “touch” in other words the tactile perception of the manual force necessary to open the compact.

### DESCRIPTION OF THE INVENTION

According to the invention, the compact that will contain a cosmetic product, typically a makeup powder in the form of an agglomerated powder block, comprises a cover, typically provided with a mirror, and fitted with a first hinge portion, a hollow bottom typically containing a receptacle in which the said cosmetic products will be placed, the said bottom being provided with a second hinge portion, a hinge formed by cooperation of the said first and second hinge portions, a magnetic closure based on cooperation of an upper magnet fixed to the cover with a lower magnet fixed to the said bottom facing the upper magnet, and possibly an applicator of the said cosmetic product, and is characterised in that:
a) the said cover comprises a so-called upper wall forming all or part of a means of attachment of the said upper magnet to the said cover, the said upper wall being typically located below the said upper magnet so as to make the said upper magnet invisible even when the said compact is opened,
b) the said bottom comprises a so-called lower wall forming all or part of the said means of attachment of the said lower magnet to the said bottom, the said lower wall being typically located above the said lower magnet, so as to make the said lower magnet invisible even when the said compact is opened,
c) the said magnets are separated by an axial distance D when the said compact is closed, chosen so as to be able to simultaneously obtain a predetermined opening force typically between 1.6 N and 2.6 N, and manual opening and closing of the compact that is not noisy, or even silent, giving an impression of softness.

This type of compact satisfies most if not all of problems that arise.

Most compacts are formed of moulded parts made of thermoplastic material and the applicant has observed that it is possible either to insert magnets, or to provide housings to insert magnets, so that these magnets are concealed from view and are at a predetermined distance when the compact is closed, so as to achieve a predetermined manual opening force.

The applicant has also observed that this type of closer has other advantages, particularly its low noise when opening or closing the compact, no doubt because there is no mobile or elastic return part, typically a hook that could make a sharp noise, the only contact or the main contact being the upper and lower walls that form typically plane horizontal surfaces.

### DESCRIPTION OF THE FIGURES

All Figures relate to compacts (1) according to the invention.

FIGS. 1a to 2c apply to the same rectangular compact (1) with dimensions 100 mm×54 mm.

FIG. 1a is a section along a vertical plane A-A shown in FIG. 2c, perpendicular to the joint plane (12) of the compact.

FIG. 1b 1a is a section along a vertical plane B-B in FIG. 2c, perpendicular to the joint plane (12) of the compact.

FIG. 1c is an enlarged partial view of FIG. 1a.

FIG. 1d is a side view.

FIG. 1e is a back view.

FIG. 2a is a top view of the bottom (6) of the compact (1).

FIG. 2b is a bottom view of the cover (2) of the compact (1).

FIG. 2c is a top view of the closed compact (1).

FIGS. 3a to 4b are partial sections in a plane A-A similar to that in FIGS. 1a and 1c that show the front parts of the covers (2) and/or the bottoms (6) according to other variants of the invention.

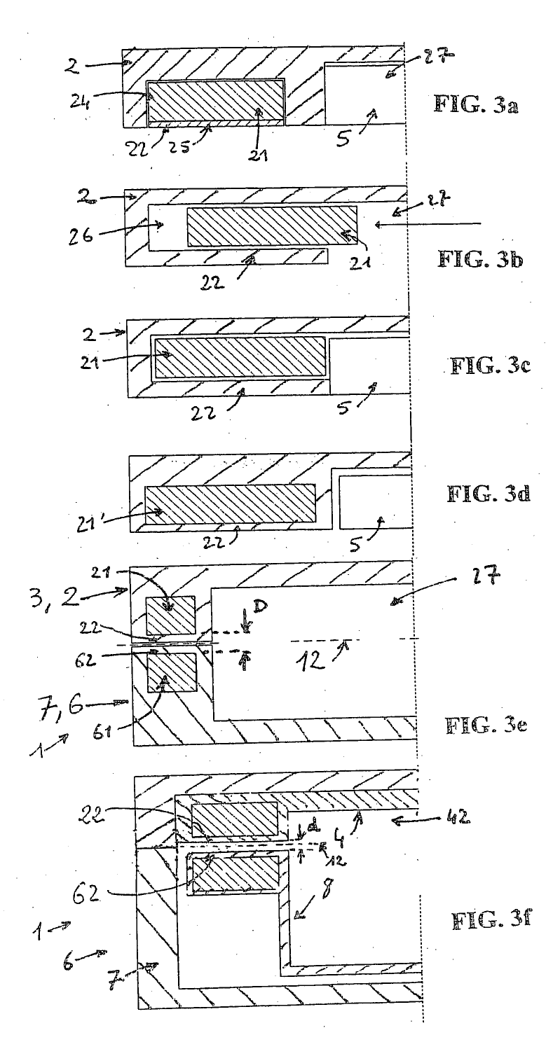

In the variant shown in FIG. 3a, the cover (2) comprises an axial upper cavity (24) in which the upper magnet (21) is housed covered with a complementary wall (25).

In the variant in FIGS. 3b and 3c, the cover (2) comprises a radial upper cavity (26) in which the upper magnet (21) is housed before attachment of the mirror (5) as illustrated in FIG. 3b, FIG. 3c showing the cover (2) after attachment of the mirror (5) that blocks any radial displacement of the upper magnet (21).

In the variants in FIGS. 3d to 3f, the upper magnet (21) and the lower magnet (61) are magnets (21′, 61′) embedded in the body of the material forming the said cover (2) or the said upper shell (3) in the case shown in FIGS. 3d and 3e, forming the said bottom (6) or the said lower shell (7) in the case shown in FIG. 3e, forming the said upper inner frame (4) and lower inner frame (8) in the case shown in FIG. 3f.

The upper wall (22) and the lower wall (62) are formed during the moulding of the corresponding parts.

FIG. 3d shows a front part of the cover similar to that shown in FIG. 3a.

FIGS. 3e and 3f show the front parts of the closed compacts (1).

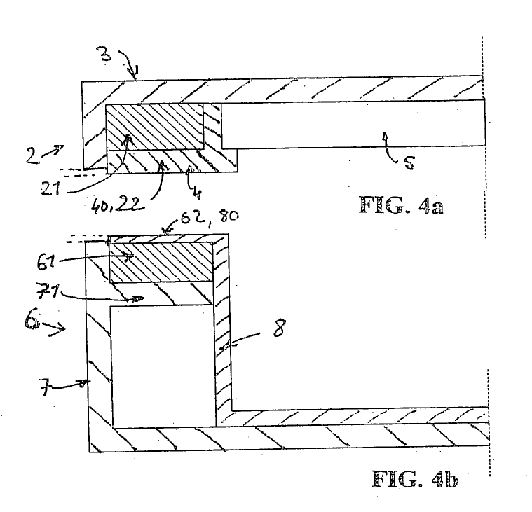

FIGS. 4a and 4b illustrate the front parts of a cover (2) and a bottom (6) respectively, in which the upper magnet (21) and the lower magnet (61) are blocked in a housing formed by cooperation of the upper shell (3) and the upper inner frame (4) in the case of the cover (2), an upper portion (40) of the said upper inner frame (4) forming the said upper wall (22), or formed by cooperation of the lower shell (7) comprising a radial projection (71) and the lower inner frame (8) in the case of the bottom (6), a portion (80) of the said inner frame (8) forming the said lower wall (62).

### DETAILED DESCRIPTION OF THE INVENTION

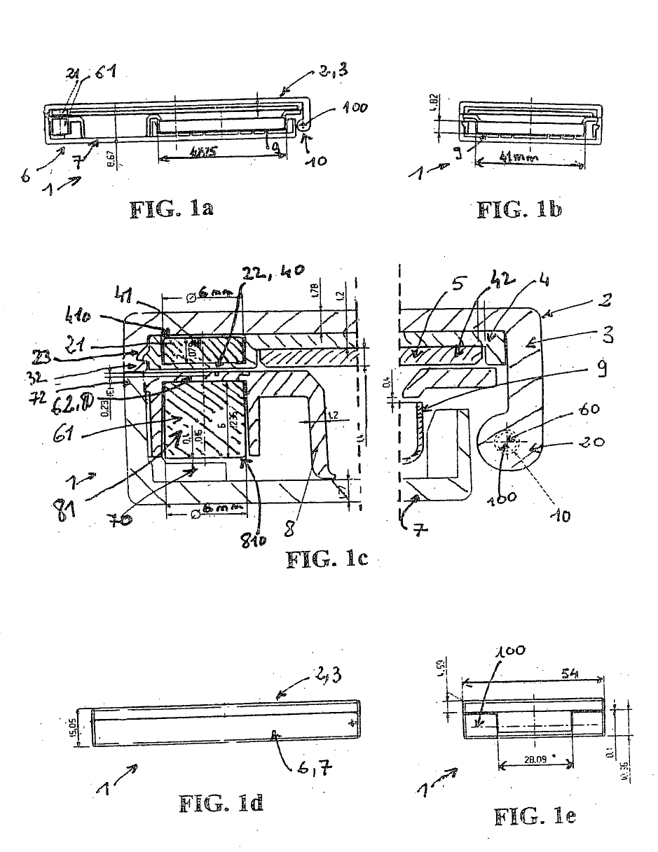

According to the invention and as illustrated for example in FIG. 1C, FIG. 3f and FIG. 4b, the said bottom (6) may comprise a so-called lower outer shell (7) and a so-called lower inner frame (8) fixed to the said lower shell (7), typically by click-fitting means and in which a so-called lower portion (80) of the said lower inner frame (8) forms the said lower wall (62).

According to the invention and as illustrated in FIGS. 1c, 3f and 4a, the said cover (2) may comprise a so-called upper outer shell (3) and a so-called upper inner frame (4) fixed to the said upper shell, typically by click-fitting means, and in which the so-called upper portion (40) of the said upper inner frame (4) forms the said upper wall (22).

According to one variant of the invention illustrated in FIG. 1c, the said lower inner frame (8) may comprise a so-called lower front cavity (81) forming a so-called housing for the said lower magnet (61), and the arch in this cavity forms the said lower wall (62), the said lower cavity (81) comprising an opening (810) in its lower part, so that the said lower magnet (61) can be housed in the said cavity (81).

The said lower shell (7) may comprise an axial projection (70) capable of closing off the said opening (810) and thus blocking the said lower magnet (61) in the said lower cavity (81) such that the said lower magnet (61) is blocked when the said lower inner frame (8) is fixed, typically by click-fitting, to the said lower shell (7) to form the said bottom (6).

According to one variant of the invention illustrated in FIG. 1c, the said upper inner frame (4) may comprise a so-called upper cavity (41) forming a so-called upper housing for the said upper magnet (21), the bottom of the cavity (41) forming the said upper wall (22), the said cavity (41) including an opening (410) in its upper part, in which the said upper magnet (21) can be housed in the said upper cavity (41).

A portion of the said upper shell (3) may obstruct or close off the said opening (410) and block the said upper magnet (21) in the said upper cavity (41), such that the said upper magnet (21) is blocked when the said upper inner frame (4) is fixed, typically by click-fitting, to the said upper shell (3) to form the said cover (2).

As illustrated in FIGS. 1c, 3f and 4a, the said upper inner frame (4) may comprise a recessed part (42) in which the said mirror (5) can be placed. When the cover (2) does not comprise an upper inner frame as illustrated in FIGS. 3a to 3e, it comprises a recessed part (27) that can be used as a housing for the said mirror (5).

As illustrated in FIG. 4a, the said upper inner frame (4) may comprise or form a means of attachment of the said mirror (5), the said mirror (5) being fixed to the said cover (2) by click-fitting the said upper inner frame (4) in the said upper shell (3). One method of click-fitting (23) is shown in FIGS. 1c by cooperation of hollow and projecting elements. In this Figure, the hollow element is a groove and is carried by the said upper shell (3) on its front inner surface, and the projecting element is a rib and is carried by the said upper inner frame (4), on its front outer surface.

As illustrated in FIG. 3f, the said upper magnet (21) may be a magnet (21′) embedded in the material forming the said upper inner frame (4) or the said upper shell (3), the said upper inner frame (4) or the said upper shell (3) typically forming a moulded part made of a thermoplastic material, a layer of the said thermoplastic material forming the said upper wall (22).

As illustrated in FIGS. 3d and 3e, the said upper magnet (21) may be a magnet (21′) embedded in the material forming the said cover (2), the said cover (2) typically forming a moulded part made of thermoplastic material, a layer of the said thermoplastic material forming the said upper wall (22).

As illustrated in FIG. 3f, the said lower magnet (61) may be a magnet (61′) embedded in the material forming the said lower inner frame (8) or the said lower shell (7), the said lower inner frame (8) or the said lower shell (7) forming a moulded part made of a thermoplastic material, a layer of the said thermoplastic material forming the said lower wall.

As illustrated in FIG. 3e, the said lower magnet (61) may be a magnet (61′) embedded in the material forming the said bottom (6), the said bottom (6) forming a moulded part made of a thermoplastic material, a layer of the said thermoplastic material forming the said lower wall.

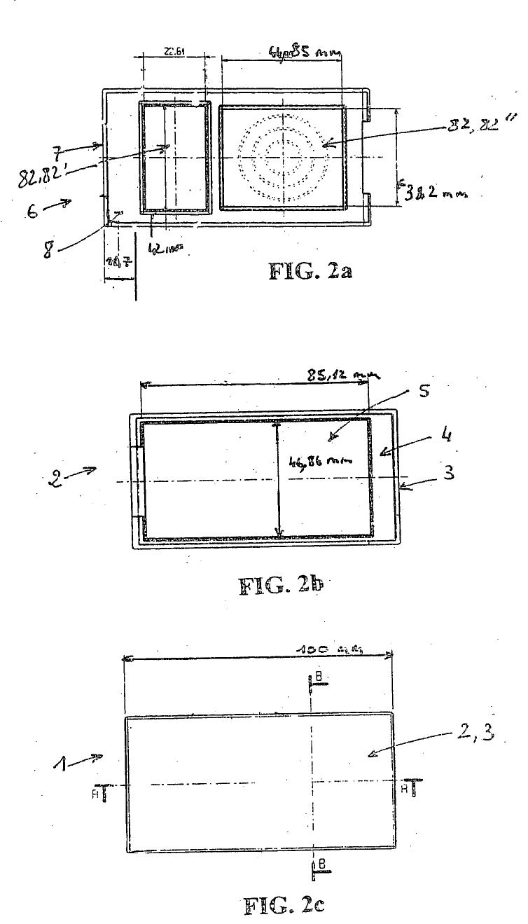

As illustrated in FIG. 2a, the said lower inner frame (8) may comprise at least one compartment (82) and typically two compartments, a first compartment (82′) being designed to form a housing for the said application means, typically a powder puff, a second compartment (82″) being designed to contain the said cosmetic product or a receptacle (9) containing the said cosmetic product.

As illustrated for example in FIGS. 3e, 4a and 4b, the joint plane or the contact plane (12) between the said cover (2) and the said bottom (6) may be formed or may comprise a contact between the said upper wall (22) and lower wall (62) the said axial distance D then corresponding to the sum of the thicknesses of the said upper wall (22) and lower wall (62), the said upper wall (22) and lower wall (62) being in contact when the compact is closed.

In this case, the said upper wall (22) and/or the said lower wall (62) may be formed from a plastic material with a hardness chosen specifically so that the said compact (1) can be closed silently.

As illustrated for example in FIGS. 1c and 3f the joint plane or contact plane (12) between the said cover and the said bottom (6) may be formed or may comprise a contact between a so-called upper edge (32) of the said upper shell (3) and a so-called lower edge (72), of the said lower shell (7), the said upper wall (22) and lower wall (62) being separated by a distance d typically varying from 0.05 mm to 0.4 mm, and preferably from 0.1 mm to 0.3 mm, which may be advantageous to obtain an opening with a “soft” feel. See FIG. 3f.

In this case, the said upper shell (3) and/or the said lower shell (7) may be formed from a plastic material with a hardness chosen specifically so that the said compact (1) can be closed silently.

As illustrated on the compact in FIGS. 1a to 2c, the said upper magnet (21) and lower magnet (61) may be cylindrical magnets with a diameter varying from 4 to 10 mm, or preferably from 5 mm to 7 mm, and typically 6 mm.

The said upper magnet (21) may have an axial height varying from 1 mm to 5 mm, and preferably from 1.5 mm to 3 mm and, typically 2 mm.

The said lower magnet may have an axial height varying from 3 mm to 10 mm, and preferably from 5 mm to 8 mm and, typically 6 mm.

According to the invention, the said distance D may vary from 0.5 to 2.5 mm, and preferably from 1 to 2 mm and typically 1.2 to 1.8 mm.

### Example Embodiments

A compact (1) according to FIGS. 1a to 2c was manufactured by injection moulding of thermoplastic parts.

The compacts (1) or covers (2) and bottoms (6) of the compacts (1) were also manufactured according to FIGS. 3a to 4b.

In these example compacts, the thicknesses of the upper wall (22) and lower wall (62) were taken equal to 0.8 mm, such that the distance D between the magnets or the air gap was equal to 1.6 mm when these walls (22, 62) were in direct contact, for example as in the case shown in FIGS. 3a and 4a, this distance D being equal to 1.8 mm in other cases, for example in the case shown in FIGS. 1c and 3f. In the case shown in FIGS. 1c and 3f, the distance d between the upper wall (22) and the lower wall (62) was 0.2 mm.

### ADVANTAGES OF THE INVENTION

Compacts according to the invention firstly have an aesthetic advantage since the closer of these compacts is completely invisible, even when the compacts are opened.

Another advantage is during use, because it is easy to vary the axial distance D separating the upper magnet (22) from the lower magnet (61), to achieve an opening force adapted to the habits of users.

Another advantage is the touch or sensation felt when opening and/or closing, particularly by the possibility of having a typically silent contact by choosing materials that may be different for the shells (3, 7) and for the inner frames (4, 8).

They also have an economic advantage to the extent that traditional closers can be eliminated, and magnets can be assembled to their supports at high rate, regardless of whether these supports are formed by inner framees (4, 8), covers (2) and the bottoms (6) themselves, or possibly the shells (3, 7), particularly when the magnets are embedded in the thermoplastic moulding material when the parts of the compact are moulded.

Finally, the invention can be applied to many different types of existing compacts.

### List of Marks

Compact . . . 1
   Hinge . . . 10
      Rotation axis . . . 100
   Magnetic closer . . . 11
   Joint plane . . . 12
Cover . . . 2
   First portion of hinge . . . 20
   Upper magnet of 2 and 11 . . . 21, 21′
   Upper wall . . . 22
   Click-fitting means of 3 and 4.23
   Axial upper cavity . . . 24
   Complementary wall . . . 25
   Radial upper cavity . . . 26
   Part recessed to hold 5 . . . 27
Upper shell of 2 . . . 3
   Upper cavity . . . 30
   Complementary wall . . . 31
   Upper contact edge . . . 32
Upper inner frame of 2 . . . 4
   Upper portion=22 . . . 40
   Upper cavity . . . 41
      Opening of 41 . . . 410
   Part recessed to hold 5 . . . 42
Mirror . . . 5
Bottom . . . 6
   Second portion of hinge . . . 60
   Lower magnet of 4 and 11 . . . 61, 61′
   Lower wall . . . 62
Lower shell of 6 . . . 7
   Axial or vertical projection . . . 70
   Radial or plane projection . . . 71
   Lower contact edge . . . 72
Lower inner frame of 6 . . . 8
   Lower portion=62 . . . 80
   Lower cavity . . . 81
      Opening of 81 . . . 810
   Compartment . . . 82, 82′, 82″
Receptacle . . . 9

1. Compact (1) designed to contain a cosmetic product, typically a makeup powder in the form of an agglomerated powder block, comprising a cover (2), typically provided with a mirror (5), placed with a first hinge portion (20), a hollow bottom (6) typically containing a receptacle (9) in which the said cosmetic products will be placed, the said bottom (6) being provided with a second hinge portion (60), a hinge (10) formed by cooperation of the said first and second hinge portions (20, 60), a magnetic closure (11) based on cooperation of an upper magnet (21) fixed to the cover (2) with a lower magnet (61) fixed to the said bottom (6) facing the upper magnet, and possibly an applicator of the said cosmetic product, characterised in that:
a) the said cover (2) comprises a so-called upper wall (22) forming all or part of an means of attachment of the said upper magnet (21) to the said cover (2), the said upper wall (22) being typically located below the said upper magnet (21) so as to make the said upper magnet (21) invisible even when the said compact (1) is opened,
b) the said bottom (6) comprises a so-called lower wall (62) forming all or part of the said means of attachment of the said lower magnet (61) to the said bottom (6), the said lower wall (62) being typically located above the said lower magnet (61), so as to make the said lower magnet invisible even when the said compact (1) is opened,
c) the said upper wall (22) and lower wall (62) being separated by a distance d typically varying from 0.05 mm to 0.4 mm, and preferably from 0.1 mm to 0.3 mm,
d) the said magnets are separated by an axial distance D when the said compact is closed, chosen so as to be able to simultaneously obtain a predetermined opening force typically between 1.6 N and 2.6 N, and manual opening and closing of the compact that is not noisy, or even silent, giving an impression of softness.

2. Compact according to claim 1 in which the said bottom (6) comprises a so-called lower outer shell (7) and a so-called lower inner frame (8) fixed to the said lower shell (7), typically by click-fitting means, and in which a so-called lower portion (80) of the said lower inner frame (8) forms the said lower wall (62).

3. Compact according to claim 1, in which the said cover (2) comprises a so-called upper outer shell (3) and a so-called upper inner frame (4) fixed to the said upper shell, typically by click-fitting means, and in which the so-called upper portion (40) of the said upper inner frame (4) forms the said upper wall (22).

4. Compact according to any claim 2 and in which the said lower inner frame (8) comprises a so-called lower front cavity (81) forming a so-called housing for the said lower magnet (61), and the arch in this cavity forms the said lower wall (62), the said lower cavity (81) comprising an opening (810) in its lower part, so that the said lower magnet (61) can be housed in the said cavity (81).

5. Compact according to claim 4 in which the said lower shell (7) comprises an axial projection (70) capable of closing off the said opening (810) and thus blocking the said lower magnet (61) in the said lower cavity (81) such that the said lower magnet (61) is blocked when the said lower inner frame (8) is fixed, typically by click-fitting, to the said lower shell (7) to form the said bottom (6).

6. Compact according to claim 3 in which the said upper inner frame (4) comprises a so-called upper cavity (41) forming a so-called upper housing for the said upper magnet (21), the bottom of the cavity (41) forming the said upper wall (22), the said cavity (41) including an opening (410) in its upper part, in which the said upper magnet (21) can be housed in the said upper cavity (41).

7. Compact according to claim 6 in which a portion of the said upper shell (3) obstructs or closes off the said opening (410) and blocks the said upper magnet (21) in the said upper cavity (41), such that the said upper magnet (21) is blocked when the said upper inner frame (4) is fixed, typically by click-fitting, to the said upper shell (3) to form the said cover (2).

8. Compact according to claim 3 in which the said upper inner frame (4) comprises a recessed part (42) in which the said mirror (5) can be placed.

9. Compact according to claim 8 in which the said upper inner frame (4) comprises or forms a means of attachment of the said mirror (5), the said mirror (5) being fixed to the said cover (2) by click-fitting the said upper inner frame (4) in the said upper shell (3).

10. Compact according to claim 1 in which the said upper magnet (21) is a magnet (21′) embedded in the material forming the said upper inner frame (4) or the said upper shell (3), the said upper inner frame (4) or the said upper shell (3) typically forming a moulded part made of a thermoplastic material, a layer of the said thermoplastic material forming the said upper wall (22).

11. Compact according to claim 1 in which the said upper magnet (21) is a magnet (21′) embedded in the material forming the said cover (2), the said cover (2) typically forming a moulded part made of thermoplastic material, a layer of the said thermoplastic material forming the said upper wall (22).

12. Compact according to claim 1 in which the said lower magnet (61) is a magnet (61′) embedded in the material forming the said lower inner frame (8) or the said lower shell (7), the said lower inner frame (8) or the said lower shell (7) forming a moulded part made of a thermoplastic material, a layer of the said thermoplastic material forming the said lower wall.

13. Compact according to claim 1 in which the said lower magnet (61) is a magnet (61′) embedded in the material forming the said bottom (6), the said bottom (6) forming a moulded part made of a thermoplastic material, a layer of the said thermoplastic material forming the said lower wall.

14. Compact according to claim 1 in which the said lower inner frame (8) comprises at least one compartment (82) and typically two compartments, a first compartment (82′) being designed to form a housing for the said application means, typically a powder puff, a second compartment (82″) being designed to contain the said cosmetic product or a receptacle (9) containing the said cosmetic product.

15. Compact according to claim 1 in which the joint plane or the contact plane (12) between the said cover (2) and the said bottom (6) is formed or comprises a contact between the said upper wall (22) and lower wall (62) the said axial distance D then corresponding to the sum of the thicknesses of the said upper wall (22) and lower wall (62), the said upper wall (22) and lower wall (62) being in contact when the compact is closed, and in which the said upper wall (22) and/or the said lower wall (62) are (is) formed from a plastic material with a hardness chosen specifically so that the said compact (1) can be closed silently.

16. Compact according to claim 3 in which the joint plane or the contact plane (12) between the said cover and the said bottom (6) is formed or comprises a contact between a so-called upper edge (32) of the said upper shell (3) and a so-called lower edge (72) of the said lower shell (7).

17. Compact according to claim 16 in which the said upper shell (3) and/or the said lower shell (7) is (are) formed from a plastic material with a hardness chosen specifically so that the said compact (1) can be closed silently.

18. Compact according to claim 1 in which the said upper magnet (21) and lower magnet (61) are cylindrical magnets with a diameter varying from 4 to 10 mm, or preferably from 5 mm to 7 mm, and typically 6 mm.

19. Compact according to claim 18 in which the said upper magnet (21) in which the said upper magnet (21) has an axial height varying from 1 mm to 5 mm, and preferably from 1.5 mm to 3 mm and, typically 2 mm.

20. Compact according to claim 18 in which the said lower magnet has an axial height varying from 3 mm to 10 mm, and preferably from 5 mm to 8 mm and, typically 6 mm.

21. Compact according to claim 1 in which the said distance D varies from 0.5 to 2.5 mm, and preferably from 1 to 2 mm and typically 1.2 to 1.8 mm.
